(19) United States
(12) Patent Application Publication
(10) Pub. No.: US 2008/0087623 A1
(43) Pub. Date: Apr. 17, 2008

(54) Feeding bottle including an air vent for pressure equalization during feeding

(76) Inventor: Jason A. Grazioli, Sneads Ferry, NC (US)

Correspondence Address: THOMAS P. GRODT ATTORNEY AT LAW, 4 PEABOY ROAD ANNEX, DERRY, NH, 03038, US

(21) Appl. No.: 11/582,539

(22) Filed: Oct. 17, 2006

(51) Int. Cl. A61J 9/04

(52) U.S. Cl. 215/11.5

(57) ABSTRACT

A feeding bottle that includes a bottom surface that includes an axially disposed concave shaped portion that includes an air vent opening. An air vent assembly is securely disposed within the air vent opening to prevent air from leaking into the interior of the bottle or to prevent fluid from leaking out of the interior of the bottle using a closely fit connection that may include a beaded portion. The air vent assembly includes two resilient surfaces formed in a frustum shape having an upper surface. A valve opening is formed on the upper surface between the two resilient surfaces and is biased into a normally closed configuration. An air channel axially disposed within the air vent assembly and in communication with the valve opening, allows air to force the valve opening into an open configuration when the air pressure differential is greater than the bias force of the surfaces.

### BACKGROUND

Baby feeding bottles typically incorporate a flexible nipple assembly having a perforation that allow the milk, formula, juice, or other fluid to be drawn through by the child when feeding. During use, however, as the infant sucks on the nipple and withdraws the liquid contained within the bottle, a partial vacuum forms within the bottle. This vacuum can make feeding more difficult for the child by requiring the baby to suck more forcefully to overcome the vacuum. In addition, in some bottles, the air can only enter through the nipple. This constraint means that air bubbles will be found in the milk in close proximity to the nipple. When the infant again sucks on the nipple, these small air bubbles will often be ingested. The ingestion of the air leads to colic and other gastrointestinal disorders. The unwanted ingestion of air is a long-recognized problem in infant feeding.

A wide variety of vented bottle assemblies have been developed to remedy this problem. In some instances, these systems may make use of a bottom mounted valve assembly that is screwed onto the open bottom of the bottle. This bottom mounted valve assembly may contain many parts that need to be thoroughly cleaned and if not assembled properly, leakage may result.

For example in one class of bottom mounted valve assemblies, the valve assembly includes a elastomeric diaphragm extending across the entire bottom opening having a plurality of openings. As the diaphragm extends due to the difference in pressure between the interior and exterior of the bottle, at least some of the plurality of openings will open and allow air to enter the interior of the bottle. However, inverting the bottle may not be effective for opening all the valve openings, limiting the amount of vacuum that may be removed. In addition, the diaphragm may be difficult and expensive to build and may be difficult to keep clean and sanitary.

In other instances, manually operated valves have been used, or venting systems mounted on the side of the bottle have been developed as well. Neither of these systems is suitable either. As anyone knows who has fed a moving child, hands are at a premium, and using one hand to manually vent the bottle may be difficult at best. Side mounted vents require that the bottle be used in a particular orientation so that the venting system is not continuously covered by the interior fluid and unable to be used,

Thus, there is a need for a bottle having an air vent for equalizing air pressure that is simple, leak proof, and easy to keep clean and sanitary.

### SUMMARY

A feeding bottle including an air vent for pressure equalization during use is disclosed. The feeding bottle includes a bottom surface that includes an axially disposed concave shaped portion that includes an air vent opening. An air vent assembly is securely disposed within the air vent opening to prevent air from leaking into the interior of the bottle or to prevent fluid from leaking out of the interior of the bottle. The air vent assembly includes two resilient surfaces formed in a frustum shape having a valve head surface. A valve opening is formed on the valve head surface and is biased into a normally closed configuration by the resilient surfaces. An air channel axially disposed within the air vent assembly and in communication with the valve opening, allows air to force the valve opening into an open configuration when the air pressure differential is greater than the bias force of the resilient surfaces. When this occurs, air from the exterior of the bottle will enter the interior bottle equalizing the pressure during use.

In particular, the feeding bottle includes a bottle having a sidewall, an open top, and a bottom wall and interior volume defined within the sidewall, open top, and bottom wall. The bottom wall has a concave portion extending upward toward the top of the feeding bottle and an air vent is formed by an air vent edge, the air vent being situated at the center of the concave portion of the bottom wall. The air vent assembly is securely placed within the air vent opening. The air vent assembly is made from an elastomeric material and has a lower portion that seats the air vent assembly securely on the vent edge and an upper portion that sits within the interior of the bottle. The upper portion may be of any suitable shape but includes a pair of resilient surfaces that press together to form a valve opening between them. The air vent also has an air channel extending through the lower portion and the upper portion that is connected to the valve opening in order to allow air to flow through the air channel and into the interior of the bottle via the valve opening.

The feeding bottle may also include a neck portion formed near the open end and having a threaded portion that is designed to receive a cap that has a nipple that a child uses to suck on.

In one embodiment, the lower portion of the air vent assembly includes a “U” shaped portion that is designed to receive the air vent edge and using friction hold the air vent assembly securely in place. In another embodiment, the air vent edge includes a bead and the “U” shaped portion includes an indent that is sized and configured to receive the bead and hold the air vent assembly securely within the air vent hold.

The upper portion of the air vent assembly may be any suitable shape, and may be a frusto-conical or frusto-pyramidical shape that has an upper surface. In this embodiment, the resilient surfaces are the surfaces of the frusto-conical or frusto-pyramidical shapes and the valve opening is then located on and extends through the upper surface to allow air to flow between the interior and the air channel. Typically, the valve opening extends longitudinally along a portion of the upper surface.

Additional features and advantages will be set forth in the description that follows, and in part will be apparent from the description, or may be learned by practice of the disclosed feeding bottle system and apparatus. The objectives and other advantages of the feeding bottle will be realized and attained by the structure particularly pointed out in the written description and claims hereof as well as the appended drawings

### BRIEF DESCRIPTION OF THE DRAWINGS

These and other features, aspects, and advantages of the present invention will become better understood with regard to the following description, appended claims, and accompanying drawings. The drawings are not necessarily to scale, emphasis instead being placed on illustration of principles of the invention and to illustrate embodiments of the system and together with the description serve to explain the principles of at least one embodiment of the invention. The drawings include the following figures:

FIG. 1 is a side cross sectional view of a nursing bottle including the present invention;

FIG. 2 is a sectional view of the bottle depicted in FIG. 1 across line A-A′; and

FIG. 3 is a side sectional view of the air vent depicted in FIGS. 1 and 2.

### DETAILED DESCRIPTION OF THE DRAWINGS

The present invention may be understood by the following detailed description, which should be read in conjunction with the attached drawings. The following detailed description of certain embodiments is by way of example only and is not meant to limit the scope of the present invention.

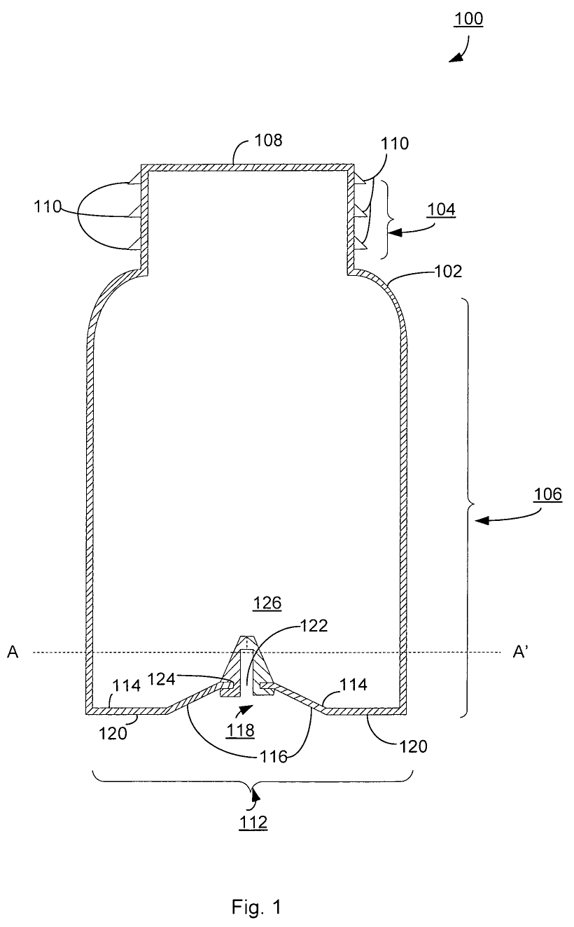

FIG. 1 depicts a baby bottle, i.e., a nursing or feeding bottle, assembly 100 including a bottle interior 101 and a bottle exterior 103. The baby bottle assembly 100 includes a bottle side 102 comprising a neck portion 104 and a body portion 106. The neck portion includes an opening 108 and a threaded portion 110 that is sized and dimensioned to receive a cap including a nipple (not shown). Other methods of attaching the cap and nipple may be used, for instance neck portion 104 may be smooth to receive a friction fitted cap and nipple or a nipple that includes an attachment portion that is sized to fit over the neck portion. Other methods may be used to attach the nipple to the bottle 102 such that opening 108 and a nipple may be in fluid communication with one another to allow a nursing child to receive fluid via the nipple.

The body portion 106 includes the side 102 and a bottom portion 112 including a bottom wall 114. The bottom wall 114 includes a convex shaped portion formed by convex wall 116 extending upward from the bottom of the bottle 102 toward the neck portion 104 forming a convex cavity 118. The convex cavity 118 is axially located to allow the bottle 102 to be placed on the bottom portion in an upright position while resting on bottom surface 120. Convex wall 116 includes an air vent opening 122 defined by air vent opening edge 124 axially located at the center of the convex cavity 118.

An air vent assembly 126 is disposed within the air vent opening 122 to prevent leakage of fluid from within the bottle 100 and to allow air from the exterior 103 to enter the interior 101 to reduce or eliminate the partial vacuum formed within the interior 101 during use. In addition, in one embodiment, the air vent assembly 126 is formed from a single piece of elastomeric material and may be removed and easily cleaned to maintain the air vent assembly 124 in a sanitary condition.

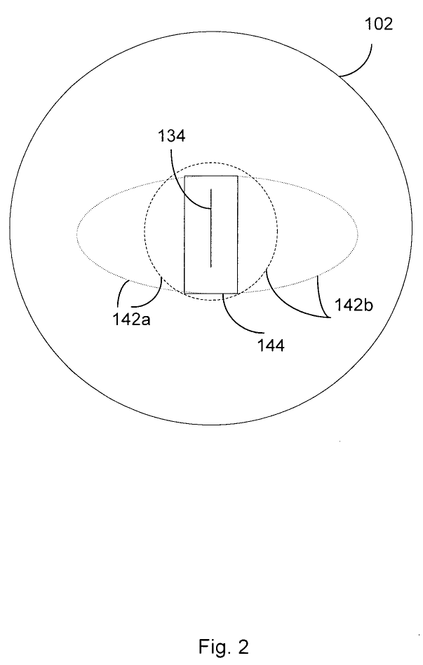

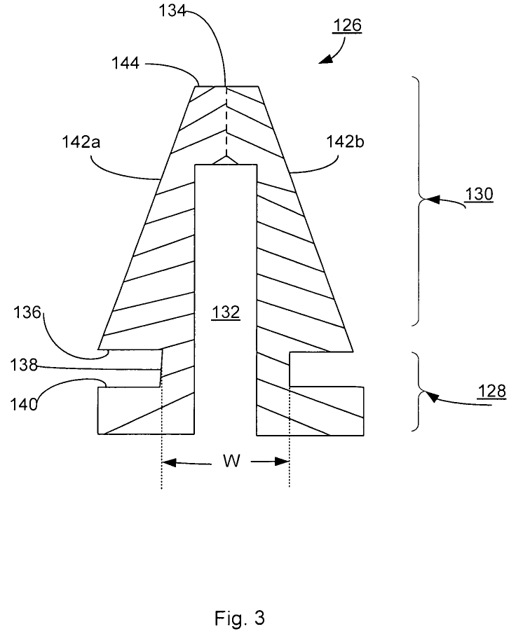

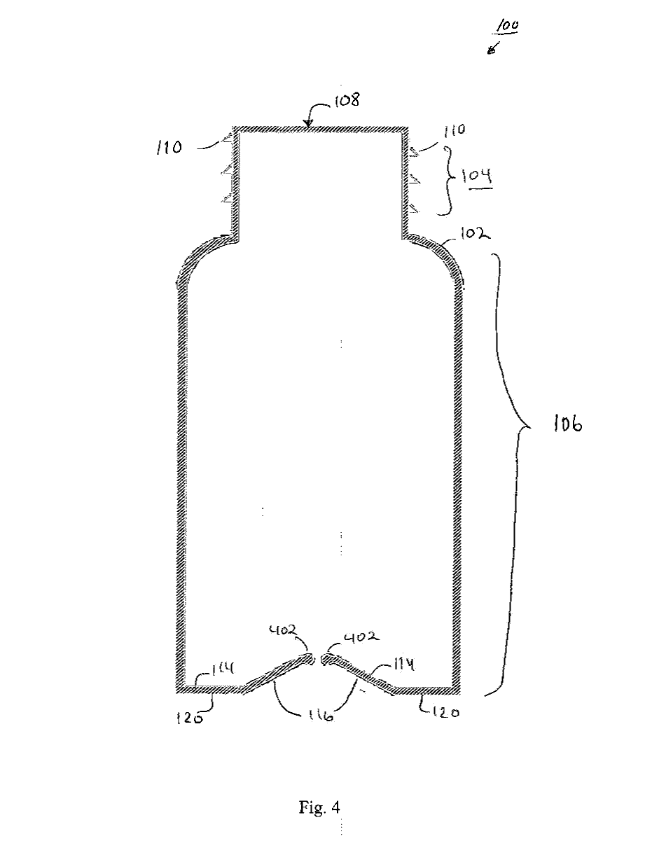

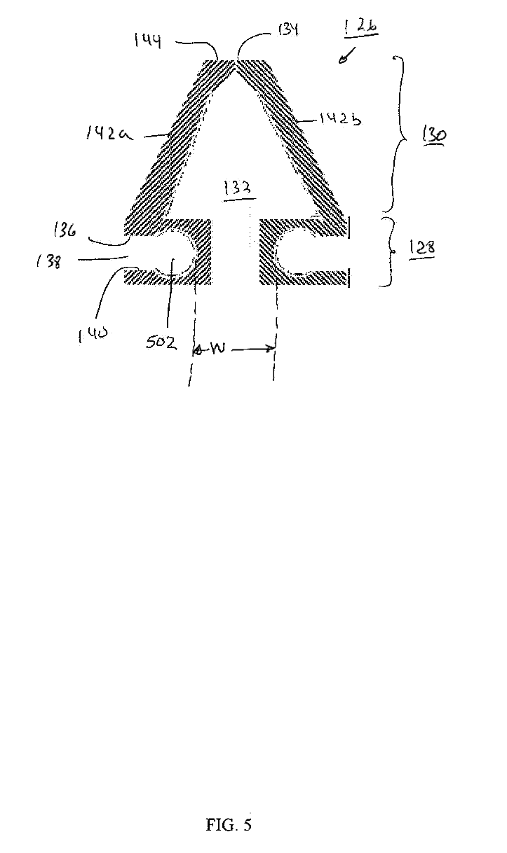

As depicted in FIGS. 1, 2, and 3, in one embodiment, the air vent assembly 126 is a unitary piece of elastomeric material that is formed into a lower portion 128 and an upper portion 130. In general, the lower portion 128 functions to hold the air vent assembly 126 securely in place within the air vent opening 122 and prevents leakage of any fluid through the vent opening 122. The upper portion 130 extends into the interior of the bottle 101 and under certain conditions that are described in more detail below functions to allow air to enter the interior 101 via air channel 132 and valve opening 134.

In one embodiment, lower portion 128 includes a “U” shaped structure that includes holding surfaces 136, 138, and 140 that are sized and dimensioned to receive and engage the air vent opening edge 124. In one embodiment, the air vent opening edge 124 is smooth and the holding surfaces 136-140 hold the air vent assembly 126 in place with friction. In another embodiment, a bead (not shown) may be formed on air vent opening edge 124 and a corresponding indent (not shown) may be formed on the appropriate surface 136-140 for greater holding strength. Typically, the width, W, of the lower portion 128 is slightly greater than the diameter of the air vent opening 122. In this way, the lower portion 128 presses outwardly against the air vent opening edge 124 via surface 138 to securely seat the air vent assembly 126 within the air vent opening 122 to provide a leak proof and air tight seal. The lower portion 128 may be any convenient shape that is suitable for manufacturing. For example, the base portion 128 may be circular, elliptical, any suitable pyramidical shape, or a frustum.

Other methods may be used to fit the air vent assembly 126 into the air vent hole 122. For example, the air vent assembly 126 may be mounted in a threaded sleeve that is screwed into corresponding threads within the air vent hole 122. In another method, the air vent assembly may be secured in place using an adhesive.

Upper portion 130 of the air vent assembly 126 is typically a frustum shaped assembly and includes an upper surface 144. The upper portion 130 may be a frusto-conical or frusto-pyarmidical shape having resilient outer surfaces 142a, 142b, and an upper surface 144. The upper portion 130 may be of any convenient shape that is suitable for manufacturing. For example, the upper portion 130 may be circular or elliptically conical, any suitable pyramidical shape or, as discussed above, a frustum.

As discussed above, air channel 132 extends through the center of the air vent assembly 126 extending through the lower and upper portions 128 and 130, respectively, and thereby passing through the air vent opening 124. Upper surface 144 is formed between a pair of resilient outer surfaces 142a-b that form valve opening 134 therebetween. The resilient outer surfaces 142a-b are resiliently biased against one another so that the valve opening 134 is in a normally closed condition so that liquid is unable to leak through and air is unable to pass through the valve opening 134. Valve opening 134 extends through the upper surface 144 to allow air communication between the air channel 132 and the interior 101 of the bottle. In this way, air from the exterior 103 is enters the interior 101 of the bottle and equalizes the pressure between the interior 101 and exterior 103 of the bottle. In one embodiment, the valve opening 134 extends across only a portion of the upper surface 144. In another embodiment, the valve opening 134 may extend entirely across the valve head surface.

In operation, as the bottle 100 is inverted and the child sucks the fluid via the nipple (not shown), the fluid level will fall such that the upper portion 130 of the air vent assembly 126 is exposed. As the fluid is sucked out from the bottle by the child during feeding, the pressure within the interior 101 of the bottle drops below the air pressure of the exterior 103. This creates a partial vacuum within the bottle interior 101. At a certain pressure level, the higher outside pressure will force air via the air channel 132 into the valve opening 134 with sufficient force such that the resilient walls 142a-b separate and open the valve opening 134 to allow air from the exterior 103 of the bottle to flow into the interior 101 of the bottle. This allows the equalizing of the pressure between the interior 101 and the exterior 103. As the air pressure differential between the interior 101 and the exterior 103 drops, the bias of the resilient walls 142a-b overcomes the force of the air in air channel 132 and the valve opening 134 and again closes the valve opening 134.

The actual magnitude of the air pressure differential between the interior 101 and the exterior 103 that is required to open the valve opening 134 is a function of several variables. These variables include the elastomeric properties of the material of which the air valve assembly 126 is constructed from, the width of the upper portion 130, the height of the upper portion 130, the width of air channel 132, the type of conical or pyramidical shape used to form the upper portion 130, and the width and length of the valve opening 146. The actual values of these variables will be dependent upon the particulars of the system being designed and the height and diameter of the bottle 102 will have to be considered as well.

While the present invention has been particularly shown and described with references to preferred embodiments thereof, it will be understood by those skilled in the art that various changes in form and details may be made therein without departing from the spirit and scope of the invention as defined by the appended claims. All the features disclosed in this specification, including any accompanying claims, abstract, and drawings, may be replaced by alternative features serving the same, equivalent or similar purpose, unless expressly stated otherwise.

1. A feeding bottle comprising:
a bottle having a side wall, an open top, and a bottom wall, the side wall, open top and bottom wall defining the interior and exterior of the bottle;
the bottom wall including an axial portion having a concave shape, said axial concave portion extending upward toward the top of the feeding bottle, an air vent opening formed by an air vent edge, the air vent edge including a bead, the air vent opening axially disposed within the axial portion of the bottom wall; and
an air vent assembly disposed within the air vent opening, the air vent assembly being an elastomeric assembly including a lower portion configured and arranged to engage the air vent edge and further including an indent portion configured and arranged to receive said bead to securely hold the air vent assembly within the air vent opening, an upper portion disposed within the interior of the bottle said upper portion including a pair of resilient surfaces, having a frusto-conical share including an upper surface, a valve opening formed between said pair of resilient surfaces, an air channel extending though the lower portion and the upper portion and coupled to the valve opening to allow air to flow through the air channel and into the interior of the bottle via the valve opening wherein the valve opening allows air to communicate between the exterior of the bottle and the interior of the bottle.

2. The feeding bottle of claim 1, wherein the open top is formed within a neck portion of the bottle, the neck portion having a threaded portion to receive a top including a nipple and having corresponding threads, wherein the top when screwed onto the neck portion seals the bottle.

3. The feeding bottle of claim 1, wherein the lower portion includes a “U” shaped portion sized and configured to receive the air vent edge.

4. The feeding bottle of claim 13 wherein lower portion includes a “U” shaped portion to receive the air vent edge, the “U” shaped portion further including an indent sized and configured to receive the bead therein.

5. (canceled)

6. The feeding bottle of claim 5, wherein the valve opening extends longitudinally along a portion of the upper surface.

7. A feeding bottle comprising:
a bottle having a side wall, an open top, and a bottom wall, the side wall, open top and bottom wall defining the interior and exterior of the bottle;
the bottom wall including an axial portion having a concave shape, said axial concave portion extending upward toward the top of the feeding bottle, an air vent opening formed by an air vent edge, the air vent edge including a bead, the air vent opening axially disposed within the axial portion of the bottom wall;
an air vent assembly disposed within the air vent opening, the air vent being an elastomeric assembly including a lower portion configured and arranged to engage the air vent edge and further including an indent portion configured and arranged to receive said bead to securely hold the air vent assembly within the air vent opening, an upper portion disposed within the interior of the bottle said upper portion including a pair of resilient surfaces, having a frusto-pyarmidical shape including an upper surface, a valve opening formed between the resilient surfaces, an air channel extending through the lower portion and the upper portion and coupled to the valve opening to allow air to flow through the air channel and into the interior of the bottle via the valve opening
wherein the valve opening is disposed on and extends through the upper surface to allow air to communicate between the interior and the air channel.

8. The feeding bottle of claim 7, wherein the valve opening extends longitudinally along a portion of the upper surface.

9. The feeding bottle of claim 1 wherein the air vent assembly is formed as unitary elastomeric material.

10. The feeding bottle of claim 7, wherein the open top is formed within a neck portion of the bottle, the neck portion having a threaded portion to receive a top including a nipple and having corresponding threads, wherein the top when screwed onto the neck portion seals the bottle.

11. The feeding bottle of claim 7, wherein the lower portion includes a “U” shaped portion sized and configured to receive the air vent edge.

12. The feeding bottle of claim 11, wherein the lower portion includes a “U” shaped portion to receive the air vent edge, the “U” shaped portion further including an indent sized and configured to receive the bead therein.
